(19) United States
(12) Patent Application Publication
(10) Pub. No.: US 2003/0231745 A1
(43) Pub. Date: Dec. 18, 2003

(54) Providing telephone services based on a subscriber identity

(75) Inventors: Vicki L. Colson, Deerfield Beach, FL (US); Thomas E. Creamer, Boca Raton, FL (US); Peeyush Jaiswal, Boca Raton, FL (US); Victor S. Moore, Boynton Beach, FL (US)

Correspondence Address: Gregory A. Nelson, Akerman Senterfitt, Fourth Floor, 222 Lakeview Avenue, P.O. Box 3188, West Palm Beach, FL, 33402-3188, US

(73) Assignee: International Business Machines Corporation, Armonk, NY

(21) Appl. No.: 10/172,257

(22) Filed: Jun. 14, 2002

(51) Int. Cl. H04M 1/64

(52) U.S. Cl. 379/88.01

(57) ABSTRACT

A method of providing a telephony service can include receiving a spoken utterance from a subscriber and determining a subscriber identity according to the spoken utterance. A telephony service associated with the subscriber can be activated according to the determined subscriber identity.

### BACKGROUND OF THE INVENTION

1. Technical Field

This invention relates to the field of telephony, and more particularly, to providing telephony services to subscribers.

2. Description of the Related Art

The delivery of most telephony services and features are tied to the directory number of a calling party or a called party. In fact, nearly all of the activities performed by a conventional telephony system, whether the public switched telephone network (PSTN) or an Internet protocol (IP) telephony system, are based on such directory numbers. The dialed directory number can be referred to as the DNIS in reference to directory number identification service, a service which identifies for a receiving party the number dialed by a calling party. The directory number of the calling party can be referred to as an ANI in reference to automatic number identification, the service which provides the receiving party with the directory number of the calling party.

For example, when a calling party initiates a call to a receiving party, the DNIS and the ANI can be used to authenticate the call. Authentication can include tasks such as finding the ANI in a list of authorized subscribers and ensuring that the DNIS is valid. Taking another example, the switching of calls to and from a subscriber also can be achieved through the use of the subscriber's directory number. That is, if a calling party places a call to a receiving party, the call can be routed to the receiving party based on an area code and/or an exchange code of the DNIS.

The reliance of conventional telephony systems on the DNIS and ANI not only determines how features and services are to be implemented and delivered, but also can dictate the mode of operation of other major portions of the telephony system. In illustration, telephony billing systems are largely based upon the directory number of a subscriber. Given the mobile nature of today's society, however, billing subscribers according to their directory number may not be the most efficient billing method available. For example, as a subscriber moves from one location to another, the subscriber may utilize telephony equipment associated with a directory number that is different from that of the “mobile” subscriber. Yet conventional telephony systems continue to link the delivery of telephony services with directory numbers.

### SUMMARY OF THE INVENTION

The invention disclosed herein provides a solution for activating telephony services based upon identifying information which can be provided by the subscriber. One aspect of the present invention can include a method of providing a telephony service. The method can include receiving a spoken utterance from a subscriber, determining a subscriber identity according to the spoken utterance, and activating a telephony service associated with the subscriber according to the determined subscriber identity.

According to one embodiment of the present invention, the subscriber identity can be determined without using directory number identification service or automatic number identification service. For example, the identifying information can be determined by speech recognizing the received spoken utterance. The identifying information can be matched to a subscriber identity in a listing of subscriber identities. Notably, the subscriber identity can be verified by speech recognizing a subscriber provided password associated with the subscriber identity. According to one embodiment of the present invention, the matched subscriber identity can specify the activated telephony service. Alternatively, the identifying information can specify the telephony service to be activated. For example, the subscriber can issue a spoken utterance requesting the telephony service.

According to another embodiment of the invention, voice identification can be performed on the spoken utterance to determine the identifying information. The identifying information can be matched to a subscriber identity in a listing of subscriber identities. The subscriber identity can be verified by speech recognizing a subscriber provided password associated with the subscriber identity. The subscriber identity can specify the telephony service to be activated. Alternatively, the spoken utterance can be speech recognized to determine the telephony service to be activated.

Another aspect of the present invention can include a telephony service delivery system. The system can include an interface configured to receive call information including signaling information and a spoken utterance from a subscriber. The interface can be configured to receive the call information from a telephony system and provide the call information to at least one other device communicatively linked through an IP network. The system also can include an audio processor for determining identifying information associated with the subscriber from the spoken utterance. The audio processor can include a voice recognizer for identifying a voice of a subscriber according to the spoken utterance. Alternatively, the audio processor can include a speech recognizer for deriving textual representations of spoken utterances. Still, the audio processor can include a both a voice recognizer and a speech recognizer. The system further can include a telephony application server configured to activate at least one telephony service according to the identifying information of the subscriber.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 depicts a telephony system in accordance with the inventive arrangements disclosed herein.

FIG. 2 is a flow chart illustrating a method of delivering a telephony service as performed by the system of FIG. 1.

### DETAILED DESCRIPTION OF THE INVENTION

The invention disclosed herein provides a solution for activating telephony services for subscribers. In particular, the present invention can obtain identifying information from a caller through an audio interface. Speech recognition and/or voice identification processing techniques can be applied to the caller provided information, for example spoken utterances, to uniquely identify the caller. The identifying information can be used to activate one or more telephony services for processing the call, initiating other calls, implementing voice mail, and the like. Although the present invention can be configured to allow callers to request services through the audio interface, telephony services also can be associated with particular user identities, thereby allowing such telephony services to be automatically implemented upon identification of the caller.

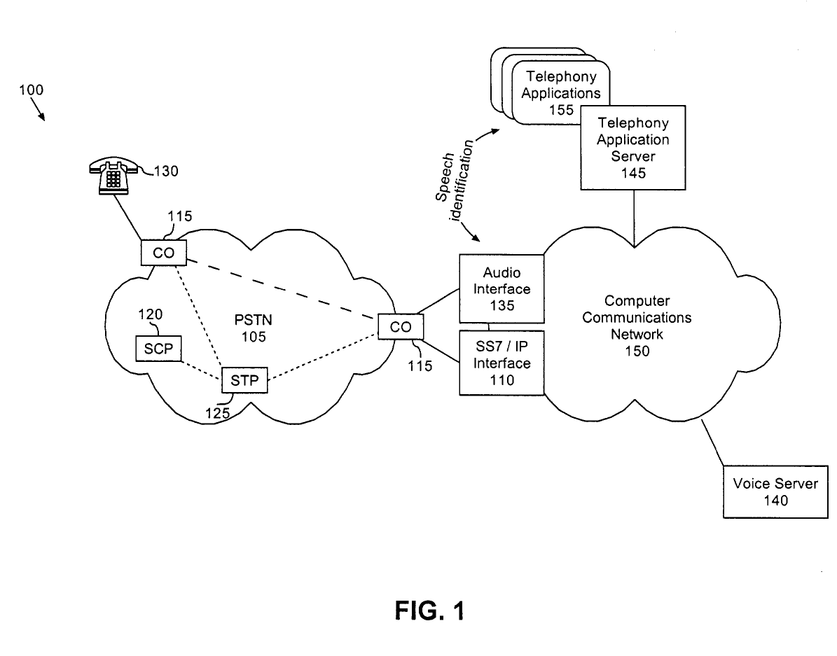

FIG. 1 depicts a telephony system 100 in accordance with the inventive arrangements disclosed herein. The system 100 can include a public switched telephone network (PSTN) 105 and a computer communications network 150. The PSTN 105 can include various nodes providing circuit-switched transfer of voice data and packet-switched transfer of signaling data. For example, the PSTN 105 can include central offices (CO) 115 providing local access to telephone 130. The PSTN 105 also can include one or more signaling transfer points (STP) 125 for routing signaling data, such as signaling system 7 (SS7) information, between one or more central offices 115, and service control points (SCP) 120 which provide interfaces to databases in the telephony system. The STPs 125 and the SCPs 120, at least in part, form the signaling network in the PSTN 105 supporting call control functions such as call set up, call maintenance, and call tear down.

The PSTN 105 can be communicatively linked to the computer communications network 150 through a protocol translating network device such as a bridge for example. Accordingly, as shown in FIG. 1, the PSTN 105 can be communicatively linked to the computer communications network 150 via an appropriate signaling interface 110 and audio interface 135. The signaling interface 110 can include an SS7 to Internet protocol (IP) bridge which can map directory numbers received via the SS7 signaling network of the PSTN 105, such as “800” numbers, to equivalent IP addresses.

The audio interface 135 can receive voice data from the PSTN 105. In particular, calls can be terminated into the audio interface 135. Accordingly, the audio interface 135 can convert or packetize the voice data received from the PSTN 105 for communication over an IP network such as the computer communications network 150. Similarly, the audio interface 135 can receive audio data from the computer communications network 150 and format convert the audio data for sending over the PSTN 105.

The audio interface 135 can include a text-to-speech system for converting text to an audio stream as well as an audio playback system. For example, the audio interface 135 can be an interactive voice response unit (IVR), which can receive calls and support dialog with a caller in the execution of telephony services. It should be appreciated by those skilled in the art that although the voice interface 135 and the signaling interface 110 are depicted as being separate from the PSTN 105, that such interfaces can be located within the any suitable node of the PSTN 105, between the PSTN 105 and the computer communications network 150, or as a “front end” to the computer communications network 150. Moreover, the SS7/IP interface 110 and the audio interface 135 can be combined into a single unified telephony interface.

The computer communications network can include any packet-switched network, for example, a local area network (LAN), a wide area network (WAN), the Internet, or the like. Accordingly, the computer communications network 150 can communicatively link the signaling interface 110, the audio interface 135, a telephony application server 145, and a voice server 140. For example, the SS7/IP interface 110, the voice interface 135, the telephony application server 145 and the voice server 140 can communicate with one another using IP and/or transmission control protocol over Internet protocol (TCP/IP). Still, the invention is not so limited by the particular communications protocol used. For example, various components linked via the computer communications network 150, such as the audio interface 135, the voice server 140, and the telephony application server 145, can communicate using remote method invocation for use with distributed Java based applications.

The telephony application server 145 can include one or more telephony applications 155 (services). For example, the telephony services can include, but are not limited to, voice activated dialing, directory number translation, voice mail services, billing related services, and the like. The voice server 140 can provide voice processing features such as a speech recognition system for recognizing speech and a voice processing system for matching a subscriber voice to a known subscriber voice profile, a text-to-speech system for converting text to an audio stream, as well as an audio playback system. Notably, according to another embodiment of the present invention, the audio interface 135 also can be configured to provide speech recognition and voice identification functions. For example, such can be the case where the audio interface 135 is an interactive voice response unit (IVR), which can receive calls and support dialog with a caller in the execution of telephony services.

In operation, a subscriber can originate a call using telephone 130. The call can be routed through the PSTN 105 to the SS7/IP interface 110 and the audio interface 135. That is, a voice pathway can be setup between central offices 115 using the SS7 signaling network operating over telephony switches in the central offices 115, the STP 125, and if necessary, the SCP 120. As the call control information is received by the SS7/IP interface 110, that information can be provided to the telephony application server 145, which can instruct the SS7/IP interface 110 to terminate the call onto the audio interface 135. By engaging the subscriber in dialog, the audio interface 135 can obtain speech from the subscriber.

From the subscriber's speech, information capable of uniquely identifying the subscriber can be determined. For example, the speech can be provided from the audio interface 135 to the voice server 140 for speech recognition and/or voice identification. As mentioned, if the voice interface 135 is equipped with speech recognition and/or voice identification, the voice server 140 need not be included. Regardless, the speech recognition results and/or voice identification results can be provided back to the voice interface and forwarded to the telephony application server 145, or alternatively, can be provided directly to the telephony server 145. The telephony application server 145 can utilize the speech recognition results and/or voice identification results to activate a telephony application or service 155 for processing the received call.

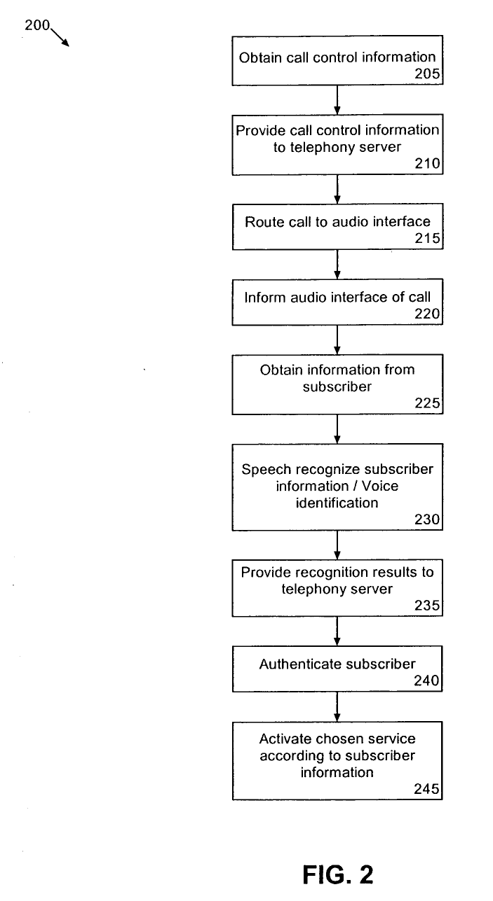

FIG. 2 is a flow chart illustrating a method 200 of delivering a telephony service as performed by the system of FIG. 1. The method can begin in a state wherein a subscriber has initiated a call and the call control information associated with that call has been provided to the SS7/IP interface or bridge. Accordingly, in step 205, the call control information can be obtained, for example through the SS7 signaling network. The call control information can be format converted for transmission through the IP network. Translation of the call control information can include translating portions of the call control information to one or more IP addresses, for example the IP address of the telephony application server and/or the audio interface.

In step 210, the call control information can be provided to the telephony application server. In step 215, the telephony application server can determine that the call is to be terminated onto the audio interface. Accordingly, the telephony application server can instruct the SS7/IP interface to do so. In step 220, the telephony application server can notify the voice interface of the call as well as provide any information that may be required by the audio interface to process the received call. The telephony server can instruct the voice interface as to the type of dialog to engage the subscriber, what questions to ask, and/or what responses to record. For example, the telephony server can send or specify a voice markup language script such as a voice extensible markup language (VXML) script to be executed. Alternatively, the audio interface can implement a default algorithm, program, and/or script.

In step 225, information can be obtained from the subscriber. The audio interface can present various voice prompts to implement a dialog with the subscriber. For example, the subscriber can be queried for a subscriber name, personal identification code, user name, or the like. The identifying information can be any information which can uniquely identify the subscriber and that can be collected through an audio interface. Although not required for implementing the inventive arrangements disclosed herein, the subscriber can be queried for directory numbers such as a called or dialed directory number. Regardless, the information capable of uniquely identifying a subscriber can be obtained from the subscriber directly through an audio interface rather than querying a telephony database using directory number identification service or automatic number identification service.

In step 230, the subscriber's voice responses can be processed to determine the information to uniquely identify the subscriber. The voice server can speech recognize any subscriber speech recorded by the voice interface in response to the dialog voice prompts. Thus, the voice server can determine a textual representation of the subscriber's speech. For example, the subscriber's identity can be determined by speech recognizing the subscriber's name specified in a subscriber utterance. A subscriber profile can be determined. Also, the subscriber's identity can be verified by matching a subscriber provided password to a password specified within the determined subscriber profile.

According to another embodiment of the invention, the voice server can perform a voice identification upon the received subscriber speech. That is, the voice server can perform an acoustic analysis upon the received subscriber speech (voice sample) to derive or determine a voice profile or pattern that can uniquely identify the subscriber. Notably, the voice identification can serve as an identification means, a verification means, or both. For example, if voice identification is used to identify a profile, a user provided password still can be used for purposes of subscriber verification. Alternatively, if the user is identified through another mechanism such as a subscriber response, then voice identification can be used to verify the subscriber's identity. Notably, if the subscriber provides a name as a response, then using a single subscriber utterance, the subscriber identity can be determined by speech recognizing the subscriber name and then verifying the subscriber by performing voice identification upon the received subscriber utterance. As mentioned, however, if the voice interface is equipped with speech recognition and/or voice identification functionality, then the voice interface can perform the processing described herein.

In step 235, any speech recognition results and/or voice identity results can be provided to the telephony application server. In step 240, using the identifying information received from the voice servers, the telephony application server can authenticate the subscriber. In particular, the telephony application server can verify that the subscriber has been registered for receiving telephony services. In the event that the subscriber requests one or more telephony services, the telephony application server further can verify that the subscriber is authorized to receive or activate such requested telephony services. Authentication also can include determining whether the requested telephony service is currently available.

In step 245, if the subscriber has been successfully authenticated, the telephony application server can activate one or more telephony services according to the received identifying information. The identifying information can be linked to one or more telephony services in the telephony application server through a subscriber profile. The voice server can match the received identifying information, whether a speech recognized user name, an identifier, personal identification code, or a voice profile, to one of a plurality of subscriber profiles. The profiles can specify one or more telephony applications which can be activated to process the subscriber's call which has been terminated onto the voice interface, or to initiate any other calls or activities as may be specified by the activated telephony service. Accordingly, by matching the subscriber identity, as determined from the identifying information, the subscriber can be linked to one or more telephony services to which the subscriber has been associated or registered through his or her profile.

If the subscriber specified a telephony service, that service also can be implemented. For example, in the case where the subscriber specified or requested a telephony service by issuing an appropriate voice response or command, or where the subscriber was queried as to which telephony service to activate, the subscriber specified telephony service can be activated.

The invention disclosed herein provides a solution for activating telephony services for subscribers according to information which is provided by the subscriber. The information can be provided through a voice or speech interface. By implementing telephony services according to subscriber identity, telephony services can be provided on a more personalized basis. Moreover, billing services can be can be simplified in that subscribers can be billed for services according to those services which the subscriber has utilized rather than charging the directory number from which the subscriber accessed those telephony services.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of providing a telephony service comprising:
receiving a spoken utterance from a subscriber;
determining a subscriber identity according to said spoken utterance; and
activating a telephony service associated with said subscriber according to said determined subscriber identity.

2. The method of claim 1, wherein said determining step determines said subscriber identity without using directory number identification service or automatic number identification service.

3. The method of claim 2, said determining step further comprising:
speech recognizing said spoken utterance to determine identifying information.

4. The method of claim 3, said determining step further comprising:
verifying said subscriber identity by speech recognizing a subscriber provided password associated with said subscriber identity.

5. The method of claim 3, said determining step further comprising:
matching said identifying information to a subscriber identity in a listing of subscriber identities

6. The method of claim 5, wherein said subscriber identity specifies said activated telephony service.

7. The method of claim 5, wherein said identifying information specifies said activated telephony service.

8. The method of claim 2, said determining step further comprising:
performing voice identification upon said spoken utterance to determine identifying information.

9. The method of claim 8, said determining step further comprising:
verifying said subscriber identity by speech recognizing a subscriber provided password associated with said subscriber identity.

10. The method of claim 8, said determining step further comprising:
matching said identifying information to a subscriber identity in a listing of subscriber identities.

11. The method of claim 10, wherein said subscriber identity specifies said activated telephony service.

12. The method of claim 10, said determining step further comprising:
speech recognizing said spoken utterance to determine said activated telephony service.

13. A telephony service delivery system comprising:
an interface configured to receive call information comprising signaling information and a spoken utterance from a subscriber, said interface configured to receive said call information from a telephony system and provide said call information to at least one other device communicatively linked through an IP network;
an audio processor for determining identifying information associated with said subscriber from said spoken utterance; and
a telephony application server configured to activate at least one telephony service according to said identifying information of said subscriber.

14. The system of claim 13, wherein said audio processor comprises a voice recognizer for identifying a voice of said subscriber according to said spoken utterance.

15. The system of claim 14, wherein said audio processor comprises a speech recognizer.

16. A machine-readable storage, having stored thereon a computer program having a plurality of code sections executable by a machine for causing the machine to perform the steps of:
receiving a spoken utterance from a subscriber;
determining a subscriber identity according to said spoken utterance; and
activating a telephony service associated with said subscriber according to said determined subscriber identity.

17. The machine-readable storage of claim 16, wherein said determining step determines said subscriber identity without using directory number identification service or automatic number identification service.

18. The machine-readable storage of claim 17, said determining step further comprising:
speech recognizing said spoken utterance to determine identifying information.

19. The machine-readable storage of claim 18, said determining step further comprising:
verifying said subscriber identity by speech recognizing a subscriber provided password associated with said subscriber identity.

20. The machine-readable storage of claim 18, said determining step further comprising:
matching said identifying information to a subscriber identity in a listing of subscriber identities

21. The machine-readable storage of claim 20, wherein said subscriber identity specifies said activated telephony service.

22. The machine-readable storage of claim 20, wherein said identifying information specifies said activated telephony service.

23. The machine-readable storage of claim 17, said determining step further comprising:
performing voice identification upon said spoken utterance to determine identifying information.

24. The machine-readable storage of claim 23, said determining step further comprising:
verifying said subscriber identity by speech recognizing a subscriber provided password associated with said subscriber identity.

25. The machine-readable storage of claim 23, said determining step further comprising:
matching said identifying information to a subscriber identity in a listing of subscriber identities.

26. The machine-readable storage of claim 25, wherein said subscriber identity specifies said activated telephony service.

27. The machine-readable storage of claim 25, further comprising:
speech recognizing said spoken utterance to determine said activated telephony service.
